(19) United States
(12) Patent Application Publication
(10) Pub. No.: US 2013/0297463 A1
(43) Pub. Date: Nov. 7, 2013

(54) INVENTORY MANAGEMENT SYSTEM FOR MOBILE VENDING MACHINES

(71) Applicant: Shaun F. Garber, New York, NY (US)

(72) Inventor: Shaun F. Garber, New York, NY (US)

(73) Assignee: U.S.A. Vendicab Corp., Long Island City, NY (US)

(21) Appl. No.: 13/465,813

(22) Filed: May 7, 2012

(51) Int. Cl. G06Q 10/08

(52) U.S. Cl. 705/28

(57) ABSTRACT

A system and method for managing inventory levels in mobile vending machines is disclosed. Mobile vending machines, such as those located in passenger vehicles for hire, change their location as a result of the passenger vehicle for fire driving to and from passenger destinations. The present system provides for monitoring the inventory levels of the vending machine, the distance from an inventory replenishment depot, and whether or not the vehicle currently has a fare. The system can direct vehicle's driver to proceed to a replenishment depot if the distance and inventory levels are within a threshold and the vehicle does not currently have a fare. The vending machine inventory can be replenished via the use of cartridges preloaded with inventory.

### FIELD OF INVENTION

The present invention relates to systems and methods that support mobile vending machines, and, more particularly, to a system and method for managing inventory levels within vending machines of each passenger vehicle in a fleet of passenger vehicles that are for hire.

### BACKGROUND OF THE INVENTION

Passenger vehicles for hire, such as taxis, primarily generate revenue by collecting fares from passengers as they drive passengers to desired destinations. Some taxis can include vending machines that offer for sale convenience items, such as snacks and drinks, to passengers which can be purchased while they are in the taxi. However, as passengers purchase the vending items, the vending machine inventory is depleted and the earning potential from further vending of items is reduced. Accordingly, these vending machines may require multiple refills during a taxi driver's work shift. However, the very act of refilling the vending machine during a shift has the potential to reduce the earnings from passenger fares.

It would be an improvement in the art to automatically monitor vending machine inventory levels and inventory replacement locations and automatically alert a driver to proceed to an inventory refill when certain thresholds are met. The present invention addresses these and other needs in the art.

### SUMMARY OF INVENTION

In accordance with one aspect of the present invention, a computer-implemented method for managing an inventory of a mobile vending machine located in at least one of a plurality of passenger vehicles for hire is provided. The method comprises the steps of receiving at a computer location information of the current position of a particular one of the passenger vehicles for hire, receiving at the computer inventory level information concerning a number of each of several individual vending items contained within the mobile vending machine of the particular passenger vehicles, and receiving at the computer hired status information of the particular passenger vehicle for hire. A distance is determined between the position of the particular passenger vehicle for hire and an inventory replenishment depot location. The inventory level information is compared to an inventory threshold to determine if the inventory level information is within the inventory threshold. An alert is provided at the particular passenger vehicle for hire containing the inventory replenishment depot location information if the determined distance is within a distance threshold, if the inventory level information is within the inventory threshold, and if the hired status information indicates an unhired status.

In accordance with a further aspect of the present invention, the method includes the steps of preparing an inventory replenishment bundle composed of vending items sufficient to raise an inventory level of the mobile vending machine above the inventory threshold for the individual vending items when loaded into the mobile vending machine. The inventory bundle is loaded into the mobile vending machine after the passenger vehicle for hire arrives at the replenishment depot.

In accordance with a further optional aspect of the present invention, the method includes the steps storing information to identify the contents of a bundle in a memory of the computer and transmitting to the particular vehicle for hire the information indentifying the contents of the bundle.

In accordance with another aspect of the present invention, the inventory bundle includes a cartridge that can be loaded into the vending machine.

In accordance with a further aspect of the present invention, the method includes the steps of removing a first cartridge from the vending machine, inserting a second cartridge containing vending items into the vending machine, and providing a credit for any vending items contained in the first cartridge against the cost of the vending items contained in the second cartridge.

In accordance with another aspect of the present invention, the method includes the steps of receiving item specific inventory level information concerning the vending items contained within the mobile vending machine, preparing an inventory replenishment bundle composed of vending items that correspond to specific items that have a low inventory level, and loading the inventory bundle into the mobile vending machine after the passenger vehicle for hire arrives at the replenishment depot.

In accordance with a further aspect of the present invention, the method includes the steps of identifying each specific item in the inventory replenishment bundle, storing the indentifying data, and transmitting the indentifying data to the mobile vending machine after loading.

In accordance with another aspect of the present invention, the computer system is associated with the particular passenger vehicle for hire.

In accordance with another further aspect of the present invention, the computer system is associated with a remote management cite and has a wireless communication link with the particular passenger vehicle for hire.

In accordance with a still further aspect of the present invention, the computer system is associated with the replenishment depot and has a wireless communication link with the particular passenger vehicle for hire.

In accordance with another aspect of the present invention, a computer-implemented method for managing an inventory of a mobile vending machine located in at least one of a plurality of passenger vehicles for hire is provided. The method includes the steps of receiving at a computer location information of the current position of a particular one of the passenger vehicles for hire and receiving at the computer inventory level information concerning a number of each of several individual vending items contained within the mobile vending machine of the particular passenger vehicles. A distance is determined between the position of the particular passenger vehicle for hire and an inventory replenishment depot location. The inventory level information is compared to an inventory threshold to determine if the inventory level information is within the inventory threshold. An alert is provided at the particular passenger vehicle for hire containing the inventory replenishment depot location information if the determined distance is within a distance threshold and if the inventory level information is within the inventory threshold.

In accordance with a further aspect of the present invention, the method includes the steps of receiving at the computer hired status information of the particular passenger vehicle for hire, wherein the alert is provided to a passenger if the passenger vehicle for hire has a hired status and the alert includes an option for the passenger to permit the passenger vehicle for hire to proceed to the replenishment depot, and the alert is provided to a driver if the passenger vehicle for hire has an unhired status.

In accordance with a still further aspect of the present invention, the method includes the step of providing a benefit to the passenger if the option to permit the passenger vehicle for hire to proceed to the replenishment depot is selected.

In accordance with another aspect of the present invention, a system for managing inventory of a mobile vending machine located in a passenger vehicle for hire is provided. The system includes a computer having a processor, a memory and a connection to a network. A wireless communication device is connected to the computer. The system includes a plurality of modules each comprising code that executes in the processor, including a passenger vehicle for hire location module that, when executed, configures the processor to determine a position of the passenger vehicle for hire using passenger vehicle for hire location information received via the wireless communication device. An inventory level module, when executed, configures the processor to determine the inventory of vending items contained within the mobile vending using vending inventory information received via the wireless communication device. A control module that, when executed, configures the processor to determine the hired status of the passenger vehicle for hire using hired status information received via the wireless communication device, determine a distance between the position of the particular passenger vehicle for hire and an inventory replenishment depot location, compare the inventory level information to an inventory threshold to determine if the inventory level information is within the inventory threshold, and provide an alert at the particular passenger vehicle for hire containing the inventory replenishment depot location information if the determined distance is within a distance threshold, if the inventory level information is within the inventory threshold, and if the hired status information indicates an unhired status.

These and further aspects, features and advantages of the present invention will become more apparent from the following detailed description when taken in connection with the accompanying drawings which show, for purposes of illustration only, a preferred embodiment of the present invention.

### BRIEF DESCRIPTION OF THE FIGURES

FIG. 1 illustrates an exemplary system arrangement in which a plurality of passenger vehicles for hire having vending machines are in communication with a network for management of inventory of the vending machines;

FIG. 2 depicts a flow diagram illustrating an exemplary process by which inventory is managed;

FIG. 3 depicts exemplary passenger vehicles for hire at various street positions in relation to inventory replenishment depots with a geographic location;

FIG. 4 depicts an exemplary result matrix that triggers an alert;

FIG. 5 depicts an exemplary display proximate a driver position within a passenger vehicle for hire; and

FIG. 6 depicts an exemplary cartridge containing vending items.

### DETAILED DESCRIPTION OF CERTAIN EMBODIMENTS

By way of overview and introduction, the present invention provides a system and method for managing inventory levels of mobile vending machines that are located in one or more passenger vehicles for hire. A passenger vehicle for hire, such as a taxi, typically travels to many different locations within a geographic area. A taxi's business is dependent upon being able to pick up fares, such as street hails by a passenger, who are then driven to their desired destination and a fare is collected for this service. As disclosed in co-pending applications entitled VENDING MACHINE AND CONTROL SYSTEM FOR PASSENGER VEHICLE-FOR-HIRE, application Ser. No. 12/884,643, filed Sep. 17, 2010, and PASSENGER VEHICLE-FOR-HIRE VENDING MACHINE WITH REFRIGERATION, application Ser. No. 13/257,149, filed Mar. 18, 2010, which are hereby incorporated by reference in their respective entireties, passenger vehicles for hire can include vending machines from which the passenger can purchase desired convenience items, such as food and beverages. However, as passengers purchase items from the vending machines, inventory levels will decrease. The present invention provides improvements in maintaining the inventory levels of vending machines located in passenger for hire vehicles by determining the distance between a passenger vehicle for hire and an inventory replenishment depot and the current inventory levels of the various items in the vending machine.

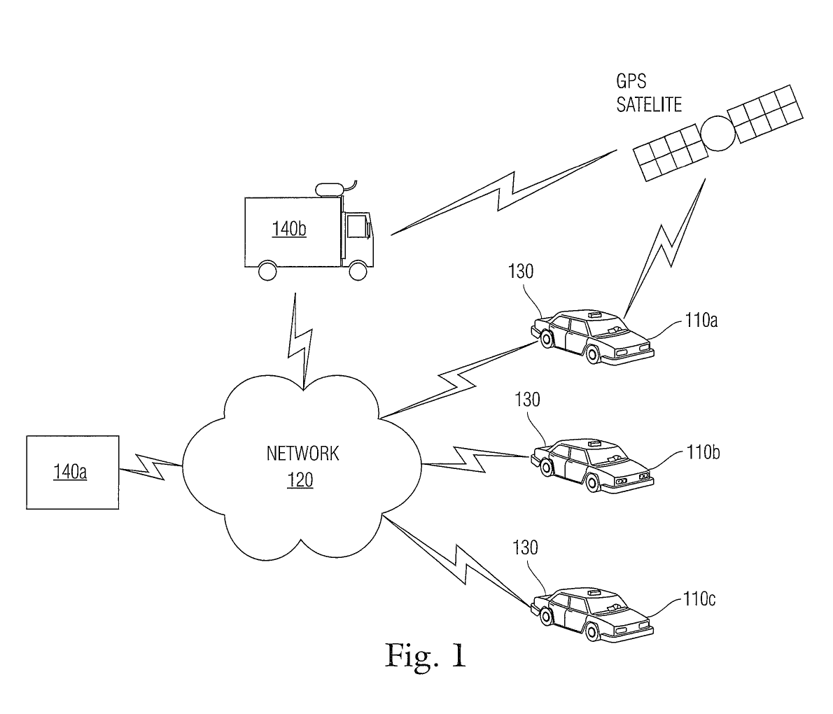

In FIG. 1, a plurality of passenger vehicles for hire 110 each include a computer system having network connectivity such as through a wireless communication link (e.g., through cellar-based data networks, wireless network connections, etc.) to a network 120. Each passenger vehicle for hire 110 includes a vending machine 130. The vending machine 130 is positioned in the passenger vehicle for hire 110 such that items can be vending to a passenger inside the passenger salon of the vehicle. For example, the vending machine 130 can be placed in the trunk of the vehicle with a passage such that items from the vending machine 130 can be received by a passenger located in the passenger salon. Inventory replenishment depots 140, which can include stationary replenishment depots 140a (e.g., warehouses, stores, service centers, etc.) and mobile replenishment depots 140b (e.g., trucks or other suitable vehicles), are also connected to the network 120 via a wireless communication link. The passenger vehicles for hire 110 and the depots 140 can also be in communication with GPS satellites.

Many passenger vehicles for hire include computer systems that track the location of the vehicle via a GPS, computer systems that display entertainment media to passengers, and computer systems that track the hired status of the passenger vehicle for hire and keep track of the fare owed by the passenger. In addition, the vending machine can also include computer systems that store and monitor inventory levels of vending items, as well as control the operation of the vending machine in order to dispense vending items. Computer systems can also be located in the driver area of the passenger vehicle for hire that provide alerts to the driver, such as alerts that cause the display on one of the vehicle's computer systems of the instructions to proceed to a refill depot in order to obtain additional vending items for the vending machines, the location of the refill depot, and directions to the depot. These computer systems located within the passenger vehicle for hire are in communication with each other. Accordingly, a passenger can use the entertainment computer system to view and order particular items from the vending machine, and when the inventory levels of the vending machine fall below a certain level for one or more items, and alert can be sent to the driver indicating that a refill is required or advisable and provide the location of the nearest refill depot. These computer systems include processors and memory and code stored in the memory that is executed by the processor. The code modules or “modules” discussed herein can be executed on the various computer systems and can be executed on one or more of the systems.

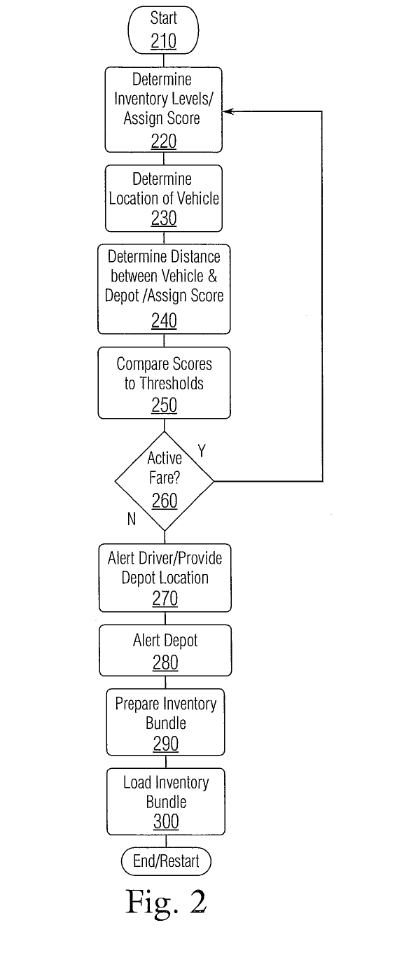

In FIG. 2, a flow diagram illustrating the operation of the system is shown. At step 210, the process starts and proceeds to step 220 at which point the system determines the inventory levels of the various vending items in the vending machine 130 located in the passenger vehicle for hire 110. An inventory module that tracks the levels of inventory in the vending machine, which can be included in the vending machine 130. As the vending machine is loaded with vending items, as discussed in more detail herein, the number and type of items are stored in memory and as items are vended to passengers, the changes in the respective inventory levels of the various, individual vending items are monitored by the inventory module. As items are refilled and vended, the levels change, which is monitored by the inventory module and changes are stored in the memory of the computer system. The inventory module is arranged to configure the processor to calculate the current inventory levels and assign an inventory score (e.g., between 0-100) that is indicative of the current inventory levels. For example, a high score indicates a high level of inventory (e.g., 100 equals full capacity) and a low score indicates a low level of inventory (e.g. 0 equals no inventory). Accordingly, as the number of items in the vending machine decreases the inventory score also decreases. An inventory score close to zero indicates that the vending machine inventory is severely depleted and inventory replenishment is required. In addition, the inventory module can monitor inventory levels on an individual, per item basis. Accordingly, if one of several items in the vending machine are depleted faster than others, the inventory module can monitor this occurrence so that a low level of a specific vending item can trigger inventory replenishment, as described in more detail below.

At step 230, the geographic location of the passenger vehicle for hire is determined. A positioning module, which can be included in the passenger vehicle for hire, has code executing so as to configure the processor of the computer system to determine the geographic location of the passenger vehicle for hire using positioning systems such as GPS and/or cell phone communications tower triangulation.

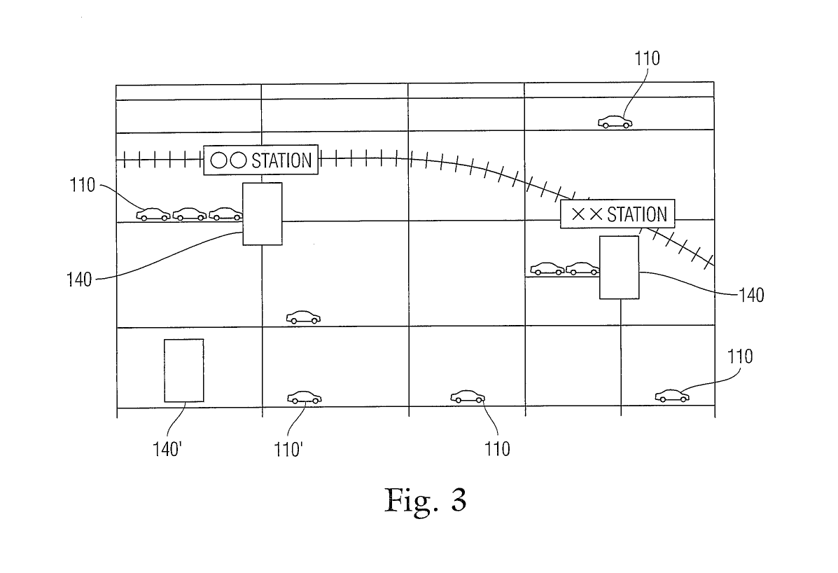

At step 240, the distance between the location of the passenger vehicle for hire and an inventory replenishment depot is determined by a distance module. If the inventory replenishment depot has a static position, such as a warehouse located at a particular address or a truck that is located in a regular consistent location (e.g., parking lot of a train station), the location of the depot can be provided to and stored in the memory prior to the passenger vehicle for hire starting a shift, for example. If the depot is mobile, such as a truck that moves to different locations throughout the day, the current location of the depot can be received via a wireless connection to the network and stored in the memory (e.g., the location of the mobile depot can be stored on a network memory or a request for the location of the vehicle can be sent to the mobile depot over the network, which is itself connected to the network). The distance module is arranged to configure the processor to calculate a distance between the current position of passenger vehicle for hire as determined in step 230 and the current position of the closest depot and to assign a distance score based on the distance between the two (e.g., between 0-100). For example, a high score can indicate that the vehicle and the depot are in close proximity (e.g., 100 for distances less than 200 feet) and a low score can indicate that the vehicle and the depot are far apart (e.g., 0 for distances greater than 15 miles). If multiple depots are available, the closest depot can be selected or logic encoded in the distance module can select a depot on a different basis (e.g., whether the depot has backlog of taxis that need to be refilled, the depot is out of stock of certain vending items, prices of items offered at depot, etc.). If the closest depot is the selection criteria, the closest depot can be determined by sorting the scores (or raw distances) and selecting the depot having the lowest score (or distance). FIG. 3 illustrates a system which includes multiple passenger vehicles for hire 110 and replenishment depots 140 within a specific geographic location (e.g. a city). For example, vehicle 110′ is closest to depot 140′ in their respective current positions and the distance between them is used to calculate the distance score. If a replenishment alert is triggered, as discussed in more detail below, the vehicle driver will be directed to proceed to that depot. Optionally, a rendezvous point between the location of the passenger vehicle for hire and the closest mobile depot can be selected. Accordingly, the system can provide location data of the rendezvous point to both the vehicle and the mobile depot so that they can both proceed to the rendezvous location.

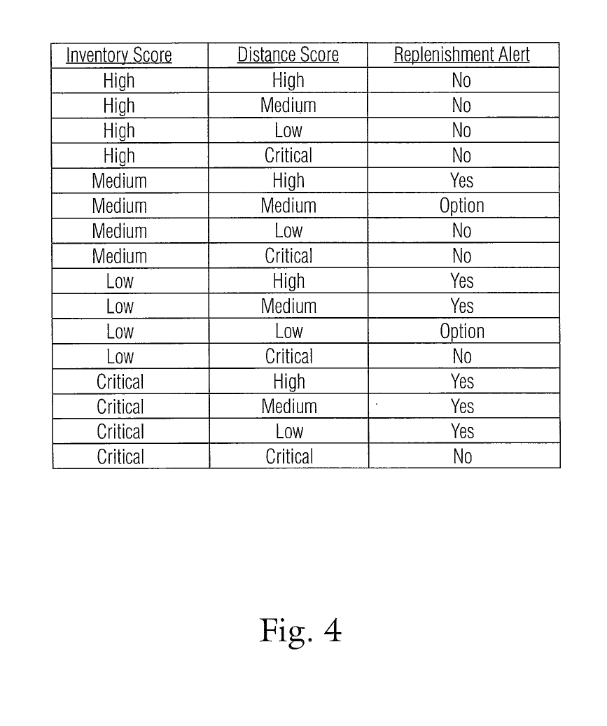

At step 250, a control module determines whether the inventory score and the distance score are within certain stored thresholds. This ensures that the system is not alerting the vehicle driver to proceed to the replenishment depot when the vending machine is at or near full inventory capacity and/or instructing the vehicle driver to travel for the purpose of restoring inventory when inventory levels are moderate. FIG. 4 is an exemplary matrix that illustrates one algorithm that can be used by the control module determine whether to trigger a replenishment alert. For example, the algorithm can be structured such that a high inventory score (e.g., 90-100) will never trigger a replenishment alert, regardless of the distance score, because stopping to refill small amounts of inventory will interfere with the vehicle obtaining passenger fares. In addition, a critical inventory score (e.g., 0-10) can always trigger a replenishment alert even if the distance score is low (meaning the vehicle will have to travel a far distance). However, if the distance score is critical, meaning that the distance is greater than a cut off (e.g., 6 or more miles), the algorithm can be structured such that a refill alert will not trigger because the cost of traveling the distance (e.g., fuel costs) outweigh the profit that could be made by vending items, for example. Optionally, the inventory score can be based on a tally of all inventory items, any specific individual inventory item that is low, or selected inventory items that the inventory module identifies as popular selections, and so on. For example, if the vending machine contains water, soda, chips, and candy as the individual vending items, if a specific item, such as soda, is being depleted at a faster rate than the other items, the system can trigger a replenishment alert if the inventory level of this individual item falls below a threshold, as described in more detail below. In addition, the control module can also receive inventory data from other passenger vehicles for hire having vending machines (e.g., received over the network) to monitor trends in inventory consumption. If the rate of inventory consumption is changing in other passenger vehicles for hire, either by total inventory or of particular items, it may be predictive of inventory consumption in a particular passenger vehicle for hire such that the thresholds (or scores) can be adjusted so that inventory levels can be maintained in order to anticipate future consumption. Threshold levels (or scores) can also be adjusted in view of other external factors (e.g., time of day or weather conditions). For example, if certain times of day are busy times for picking up passengers (which can be determine based on historical data stored in memory and/or information from other passenger vehicles for hire connected to the network), the system can be adjusted so that inventory replenishment has a lower priority, were as during slow times inventory replenishment can have a higher priority. Other factors, such as weather (e.g., maintaining higher levels of water inventory during hot weather) can also be used. Alternatively, thresholds can be set based on actually inventory level and distance values instead of using a normalizing scoring system.

At step 260, the control module determines whether the vehicle currently has an active fare, i.e., whether the vehicle has a hired status or an unhired status. This can be done by monitoring the status of the vehicle's fare meter through a connection of the fare meter to the computer system having the control module. If the fare is active, indicating that a passenger is currently in the vehicle and the vehicle is hired, the system loops back to the start position. Accordingly, the inventory score is recalculated and the distance score is recalculated as the vehicle travels towards the passenger's destination and/or items are vended to the passenger. One possible advantage to having the system calculate inventory and distance scores even with an active fare is that there is an opportunity to offer incentives to a passenger that may be willing to detour so that the vehicle may replenish its inventory even with a passenger in the vehicle. For example, if the vehicle is approaching a depot on the way to the passenger's destination and the inventory levels are low, the passenger can be presented with an option to accept the detour in exchange for a fare discount or a free vending item or a discounted vending item. This opportunity can be presented discretely to the passenger (so that the driver does not have the opportunity to influence the passenger's decision) via the vehicle's entertainment system. If the passenger accepts, the fare meter can be suspended so that the passenger is not charged for the distance traveled or time to refill and an alert can be provided to the driver to proceed to the depot. Alternatively, if the passenger attempts to select a vending item that is out of stock, the passenger can be presented with a similar opportunity assuming the inventory and distance scores are in favor of a refill. Such discounts can be offered by a particular replenishment depot in order to direct business toward the particular replenishment depot. For example, if a vehicle is close to a particular depot and has a passenger (and otherwise would not stop to replenish its vending machine inventory) the depot can send a signal to the vehicle that will trigger an option for the passenger to accept the vehicle stopping at the depot for a replenishment in exchange for a benefit. Optionally, a particular depot can offer incentives (e.g., discounts on merchandise) to drivers (over the network, which can be displayed on a display) when they do not have a passenger in order to drive business to a particular depot.

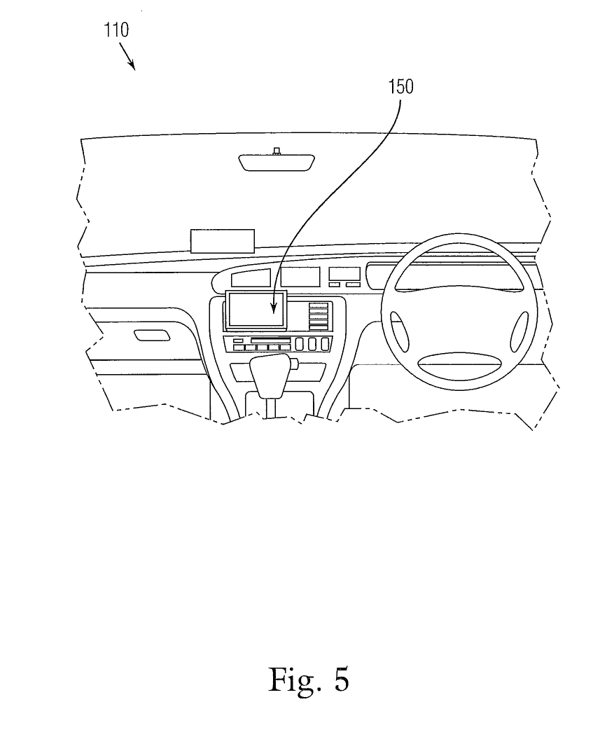

If at step 260 the fare status is inactive, meaning there is no passenger in the vehicle and the vehicle is unhired, and the distance and inventory scores are within the thresholds to trigger a replenishment alert, at step 270 the driver is automatically alerted to proceed the closest depot. The alert and location information (e.g., street address) of the depot can be provided to the driver via a display 150 (e.g., a touchscreen display), as shown in FIG. 5, for example. The system can optionally, automatically change the vehicles status to “off-duty” (e.g., change the vehicle's external status light using a signal from a control module) which will be prevent new passengers from attempting to hire the vehicle and/or also prevent the fare meter from accepting new fares. If the threshold is such that the alert is “option”, an option alert is provided to the driver along the location of the closest depot and the driver has the option to select or reject the replenish opportunity (which can be indicated using a touchscreen display 150, for example). If the driver selects replenishment, the system changes the vehicle status to “off-duty.” The alert can also include inventory information so that the driver can evaluate whether to proceed to a replenishment depot or not.

At step 280, whether the driver is automatically being directed to the nearest depot or is being directed as the result of the driver selecting the “option,” the system in one embodiment sends a signal via the network alerting the nearest depot that a vehicle will be arriving for replenishment. The signal can identify the vehicle (e.g., by license plate number, hack number, or other means) and the inventory requirements of the vehicle. For example, the vehicle's current inventory levels or an itemized inventory replenishment order can be transmitted to the depot so that the depot can know what items are required and how much of each item before the vehicle arrives at the depot. Accordingly, if the system determines that more of particular items are required (e.g., more water on a hot day), the itemized replenishment order will include higher numbers of particular items and lower numbers of others. The order can also include instructions to remove certain items from the vending machine (e.g., items that are not selling well) and replace them with other items.

At step 290, an inventory bundle is created at the depot. The inventory bundle can be vending items that are selected from the depot's storage and placed into a container (e.g., a box) so that when the vehicle arrives the vending items can be transferred from the container and loaded in the vending machine 130. An itemized list of the vending items included in the bundle can be generated and stored. For example, as items are placed into the bundle, a UPC code on the vending items can be scanned and the inventory indentifying information can be transmitted to the passenger vehicle for hire's system and stored in memory when the inventory is replenished such that the inventory module can update the vending machine inventory data. Optionally, other data concerning the inventory can be tracked and stored, such as item expirations dates. Accordingly, expiration dates can also be monitored by the inventory module such that if a vending items passes its expiration date, the system can trigger an alert to the driver to proceed to a depot for replacement of the expired items.

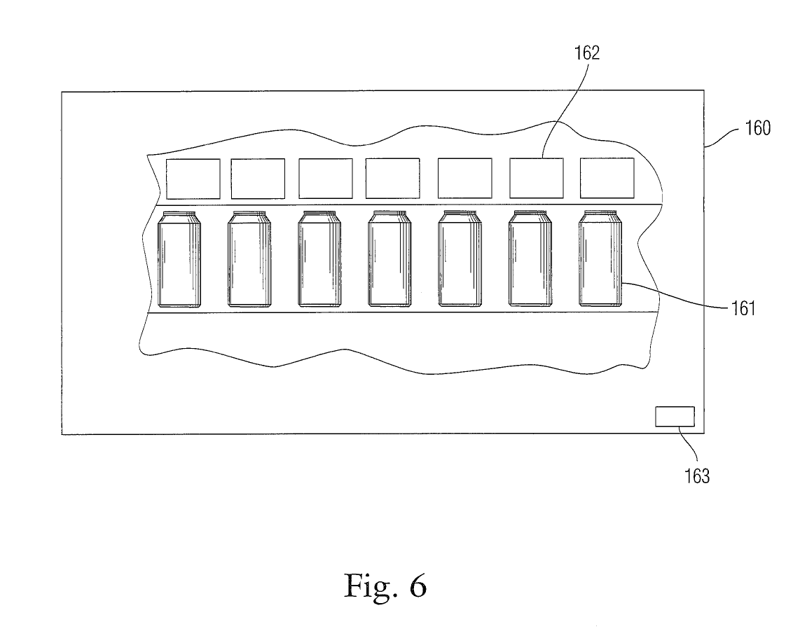

Alternatively, vending items can be stored in a cartridge 160 (FIG. 6) that can quickly be exchanged with cartridges already mounted in the vending machines located in the vehicles. Each cartridge can contain various items (e.g., beverages 161 and/or snack items 162) on different rows. Each cartridge can also include an identifier 163, such as a RFID chip or a UPC code. The number and row location of each item in the cartridge can be recorded and that information can be associated with the identifier 163. As such, when a refill cartridge 160 is selected for loading into a vending machine, the identifier can be read by an appropriate reader device and the item information data can be transmitted to the vending machine as the cartridge is being loaded into the machine. Thus, number, type, and location information of the vending items can be updated so that the vending machine can properly dispense the items. The cartridges 160 can be standardized for quick exchange with the vending machines. Accordingly, empty or partially empty cartridges can be removed from the vending machine and replaced with full cartridges. This allows for rapid refilling of the vending machines 130. The refill cartridges can be packed before the vehicle arrives at the depot and the old cartridges can be quickly swapped out. The refill cartridges can include lock-out devices that can only be opened by authorized depot personnel, which can prevent tampering with inventory and/or unauthorized refilling by drivers.

At step 300, the vehicle arrives at the depot, the vending machine 130 is accessed, and replenishment inventory is loaded into the vending machine. If cartridges are not being swapped, the vending items can be loaded with the vending items from the bundle and itemized inventory data can be transmitted (e.g., wirelessly) to the system so that the inventory module can update the inventory data (both for tracking inventory levels for replenishment purposes and providing updated vending item stock information to passengers). If a cartridge is swapped, the inventory module operates to transmit an itemized list of the inventory currently contained in the old cartridge, if any, and itemized inventory information data for the new cartridges can be received by the inventory module so that vending machine's inventory data can be updated. An itemized invoice can be generated that charges for the items that were loaded into the vehicle's vending machine, less any credits for the items in any partially filled cartridges that were removed.

After step 300, the vending inventory has been replenished, the system has been updated to reflect the new inventory, and an invoice for the inventory replenishment has been generated. Accordingly, the driver can pay the depot for the inventory or, if the driver has an account with the depot, the driver can receive the invoice at a later time. At this point, the driver can leave the depot in order to pick up new fares and the system can continue to monitor inventory levels as the inventory is again depleted.

In one embodiment, the control module can operate on a computer system associated with an individual passenger vehicle for hire. Accordingly, the control module can receive inventory data from the vending machine, location data from the GPS system, and fare status data from the fare meter that are associated with that passenger vehicle for hire. The control module can communicate with the replenishment depots and, optionally, other passenger vehicles for hire over the network via a wireless communication link. As such, each passenger vehicle for hire has its own control module that determines replenishment actions and can communication via the network to depots. A control module can also be operated on a computer systems located in a centralized location (e.g., a management client) such that information inventory data from the vending machine, location data from the GPS system, and fare status data from the fare meter of a particular passenger vehicle for hire can be received by the control system via a wireless communication link over the network, and the control system can communicate via a wireless communication link with depots. Accordingly, a centralized control system can manage the inventory in vending machines located in a plurality of passenger vehicles for hire. Each passenger vehicle for hire can transmit its inventory, fare, and location information via the network to the centralized control system at periodic time intervals or in batches at the occurrence of an event (e.g., the vending of an item or the fare status changing to unhired). A control module can also be operated on a computer system located at a replenishment depot such that inventory data from the vending machine, location data from the GPS system, and fare status data from the fare meter of a particular passenger vehicle for hire can be received by the depot control system over the network via a wireless communication link. Accordingly, a control system located at a depot could receive information regarding inventory levels in respective vehicles and transmit messages to passenger vehicles for hire that are within the vicinity of the depot in order to solicit the vehicles to stop at the depot.

While certain features of the present invention have been described as occurring on a particular machine, it would be understood by one of ordinary skill in the art that the functions described herein can be performed by various machines, interconnected, and distributed over a network. The determination of which machines perform specific functions is determined by the specific software implementation and supported hardware platforms. Accordingly, the present invention can operate in a centralized environment, wherein a server is responsible for substantially all processing, and the clients (e.g., individual passenger vehicles for hire and/or replenishment depots) display the virtual environment and communicate user-interaction to the server. Alternatively, the present invention can also be practiced in a peer-to-peer environment having little or no centralized processing, wherein the state of each client is shared with its peers as necessary and the simulation of the virtual environment is distributed across the peer network.

While the present invention has been described with respect to certain embodiments thereof, the invention is susceptible to implementation in other ways and manners which arc still within the spirit of the invention. Accordingly, the invention is not limited to the described embodiments but rather is more broadly defined by the recitations in the claims appended thereto and equivalents of the recitations therein.

1. A computer-implemented method for managing an inventory of a mobile vending machine located in at least one of a plurality of passenger vehicles for hire, comprising the steps of:
receiving at a computer location information of the current position of a particular one of the passenger vehicles for hire;
receiving at the computer inventory level information concerning a number of each of several individual vending items contained within the mobile vending machine of the particular passenger vehicles;
receiving at the computer hired status information of the particular passenger vehicle for hire;
determining a distance between the position of the particular passenger vehicle for hire and an inventory replenishment depot location;
comparing the inventory level information to an inventory threshold to determine if the inventory level information is within the inventory threshold; and
providing an alert at the particular passenger vehicle for hire containing the inventory replenishment depot location information if the determined distance is within a distance threshold, if the inventory level information is within the inventory threshold, and if the hired status information indicates an unhired status.

2. The method of claim 1, further comprising the steps of:
preparing an inventory replenishment bundle composed of vending items sufficient to raise an inventory level of the mobile vending machine above the inventory threshold for the individual vending items when loaded into the mobile vending machine; and
loading the inventory bundle into the mobile vending machine after the passenger vehicle for hire arrives at the replenishment depot.

3. The method of claim 2, further comprising the steps of:
storing information to identify the contents of a bundle in a memory of the computer; and
transmitting to the particular vehicle for hire the information indentifying the contents of the bundle.

4. The method of claim 3, wherein the inventory bundle includes a cartridge that can be loaded into the vending machine.

5. The method of claim 4, further comprising the steps of:
removing a first cartridge from the vending machine;
inserting a second cartridge containing vending items into the vending machine; and
providing a credit for any vending items contained in the first cartridge against the cost of the vending items contained in the second cartridge.

6. The method of claim 1, further comprising the steps of:
receiving item specific inventory level information concerning the vending items contained within the mobile vending machine;
preparing an inventory replenishment bundle composed of vending items that correspond to specific items that have a low inventory level; and
loading the inventory bundle into the mobile vending machine after the passenger vehicle for hire arrives at the replenishment depot.

7. The method of claim 6, further comprising the steps of:
identifying each specific item in the inventory replenishment bundle and storing the indentifying data; and
transmitting the indentifying data to the mobile vending machine after loading.

8. The method of claim 1, wherein the computer system is associated with the particular passenger vehicle for hire.

9. The method of claim 1, wherein the computer system is associated with a remote management cite and has a wireless communication link with the particular passenger vehicle for hire.

10. The method of claim 1, wherein the computer system is associated with the replenishment depot and has a wireless communication link with the particular passenger vehicle for hire.

11. A computer-implemented method for managing an inventory of a mobile vending machine located in at least one of a plurality of passenger vehicles for hire, comprising the steps of:
receiving at a computer location information of the current position of a particular one of the passenger vehicles for hire over a wireless communication link;
receiving at the computer inventory level information concerning a number of each of several individual vending items contained within the mobile vending machine of the particular passenger vehicles;
determining a distance between the position of the particular passenger vehicle for hire and an inventory replenishment depot location;
comparing the inventory level information to an inventory threshold to determine if the inventory level information is within the inventory threshold; and
providing an alert at the particular passenger vehicle for hire containing the inventory replenishment depot location information if the determined distance is within a distance threshold, and if the inventory level information is within the inventory threshold.

12. The method of claim 11, further comprising the steps of:
receiving at the computer hired status information of the particular passenger vehicle for hire; and
wherein the alert is provided to a passenger if the passenger vehicle for hire has a hired status and the alert includes an option for the passenger to permit the passenger vehicle for hire to proceed to the replenishment depot, and the alert is provided to a driver if the passenger vehicle for hire has an unhired status.

13. The method of claim 12, further comprising the steps of:
providing a benefit to the passenger if the option to permit the passenger vehicle for hire to proceed to the replenishment depot is selected.

14. A system for managing inventory of a mobile vending machine located in a passenger vehicle for hire, comprising:
a computer having a processor, a memory and a connection to a network;
a wireless communication device connected to the computer;
a plurality of modules each comprising code that executes in the processor, including:
a passenger vehicle for hire location module that, when executed, configures the processor to determine a position of the passenger vehicle for hire using passenger vehicle for hire location information received via the wireless communication device;
an inventory level module that, when executed, configures the processor to determine the inventory of vending items contained within the mobile vending using vending inventory information received via the wireless communication device;
a control module that, when executed, configures the processor to determine the hired status of the passenger vehicle for hire using hired status information received via the wireless communication device, determine a distance between the position of the particular passenger vehicle for hire and an inventory replenishment depot location, compare the inventory level information to an inventory threshold to determine if the inventory level information is within the inventory threshold, and provide an alert at the particular passenger vehicle for hire containing the inventory replenishment depot location information if the determined distance is within a distance threshold, if the inventory level information is within the inventory threshold, and if the hired status information indicates an unhired status.
